(19) United States
(12) Patent Application Publication
(10) Pub. No.: US 2016/0274258 A1
(43) Pub. Date: Sep. 22, 2016

(54) PROCESSING MICROSEISMIC DATA

(71) Applicant: WESTERNGECO LLC, Houston, TX (US)

(72) Inventor: Anthony Probert, Cambridge (GB)

(21) Appl. No.: 14/778,001

(22) PCT Filed: Mar. 18, 2014
(86) PCT No.: PCT/IB2014/059941

§ 371 Date: Sep. 17, 2015

Related U.S. Application Data
(60) Provisional application No. 61/802,997, filed on Mar. 18, 2013.

(30) Foreign Application Priority Data
Mar. 18, 2013 (GB) 1304866.5

(51) Int. Cl. G01V 1/36; G01V 1/28

(52) U.S. Cl. CPC G01V 1/364; G01V 1/288; G01V 2210/123; G01V 2210/324

(57) ABSTRACT

A method for processing microseismic data in which microseismic data is received and a filter is applied to the microseismic data. The filter is designed to whiten the frequency spectrum of the microseismic data. The filter may be a deconvolution filter. The method may allow for a very weak signal of interest to be identified in the microseismic data, even where it would have been very difficult or even impossible to identify the signal of interest in the microseismic data prior to applying the filter to the microseismic data.

### BACKGROUND

Some embodiments of this invention relate to methods and apparatuses associated with processing microseismic data.

The characterisation of subsurface strata is important for identifying, accessing and managing reservoirs. The depths and orientations of such strata can be determined, for example, by seismic surveying. This is generally performed by imparting energy to the earth at one or more source locations, for example, by way of controlled explosion, mechanical input etc. Return energy is then measured at surface receiver locations at varying distances and azimuths from the source location. The travel-time of energy from source to receiver, via reflections and refractions from interfaces of subsurface strata, indicates the depth and orientation of the strata.

In conventional seismic explorations a seismic source placed at a predetermined location, such as one or more airguns, vibrators or explosives, is activated and generates sufficient acoustic energy to cause acoustic waves to travel through the Earth. Reflected or refracted parts of this energy are then recorded by seismic receivers such as hydrophones and geophones.

In microseismic monitoring (which may be referred to as “passive” seismic monitoring) there is usually no actively controlled and triggered seismic source at a known location. The seismic energy is generated through so-called microseismic events caused by subterranean shifts and changes that at least partially give rise to acoustic waves which in turn can be recorded using suitable receivers. Microseismic events may be initiated by human activity disturbing the subterranean rock, e.g. as a consequence of injecting or extracting hydrocarbons, water, or CO2 at some subterranean formation, or as a result of controlled explosive detonations in a borehole, such as “perforation shots” or “string shots”. However, microseismic events are quite different in scale from events caused by the operation of equipment provided as an active seismic source. For example, a microseismic event may be defined as an event having a moment magnitude of less than zero.

Background information on instruments and methods for microseismic monitoring can be found for example in the U.S. Pat. Nos. 6,856,575, 6,947,843 and 6,981,550, published International patent applications WO 2004/0702424 and WO 2005/006020, and United States Published Application 2005/01900649.

A specific field within the area of microseismic monitoring is the monitoring of hydraulic fracturing. Such a hydraulic fracturing operation includes pumping fluid into a wellbore to induce cracks in the earth surrounding the wellbore, thereby creating pathways via which oil and/or gas may flow. These cracks will either be new fractures created in previously continuous rock or will be produced along pre-existing faults and fractures. In general, the pathways induced by hydraulic fracturing operations will be a combination of newly created cracks and pathways produced along pre-existing faults and fractures. As and after a crack is generated, sand or some other proppant material is commonly injected into the crack to prevent it from closing when pumping stops. The proppant particles placed within the newly formed fracture/pathway keep it open as a conductive pathway for oil and/or gas to flow into the wellbore. In the hydrocarbon industry, hydraulic fracturing of a hydrocarbon reservoir may be referred to as “stimulation” as the intent is to stimulate the production of the hydrocarbons.

In the field of microseismic monitoring, the acoustic signals generated in the course of a fracturing operation, which are caused by the generation of new cracks or displacement along existing cracks, are treated as microseismic events. Such microseismic events may occur as and after material is/has been pumped into the earth. Use may also be made of other information available from the fracturing operation, such as timing, flow rate and pressure. An example of a set of microseismic data is the Carthage Cotton Valley data, evaluated for example by James T. Rutledge and W. Scott Phillips in: “Hydraulic Stimulation of Natural Fractures as Revealed by Induced Microearthquakes, Carthage Cotton Valley Gas Field, East Texas”, GEOPHYSICS Vol. 68, No 2 pp. 441-452 (March-April 2003), and Rutledge, J. T., Phillips, W. S. and Mayerhofer, M. J., “Faulting Induced by Forced Fluid Injection and Fluid Flow Forced by Faulting: an Interpretation of the Hydraulic Fracture Microseismicity, Carthage Cotton Valley Gas Field, Texas”, BULLETIN OF THE SEISMOLOGICAL SOCIETY OF AMERICA, Vol. 94, No. 5, pp. 1817-1830 (October 2004).

Microseismic monitoring of hydraulic fracturing is a relatively recent, but nonetheless established technology. Sometimes, such monitoring may be performed using a set of geophones located in a well in the proximity of the hydraulic fracturing. In microseismic monitoring, a hydraulic fracture is created down a wellbore/borehole and data received from geophones, hydrophones and/or other sensors is processed to monitor the hydraulic fracturing. Typically the sensors are used to record microseismic data in the form of microseismic wavefields generated by the hydraulic fracturing. By inverting the acquired microseismic wavefields, locations of microseismic events may be determined as well as uncertainties for the determined locations, source mechanisms and/or the like.

The spatial and temporal location of an induced microseismic event can be used to image the dynamics of a fracture growth and to quantify the stress regime in the reservoir together with formation and fault properties. This enables the effectiveness and efficiency of fracturing operations to be optimized by providing reliable information on the in-situ and induced reservoir parameters, together with the distribution of solid material within the induced pathways. Experimental work on core samples of rock (see for example Fredd, C. N., McConnell, S. B., Boney, C. L. and England, K. W. (2000): “Experimental Study of Fracture Conductivity for Water-Fracturing and Conventional Fracturing Applications”, PAPER SPE 74138 presented at the 2000 SPE ROCKY MOUNTAIN REGIONAL/LOW PERMEABILITY RESERVOIRS SYMPOSIUM AND EXHIBITION, Denver, Colo., March 12-15) has shown that the conductivity of fractures is correlated to their width which in turn is strongly dependant on the type and amount of proppant within the fractures.

In recent times, the use of surface and/or shallow borehole seismic arrays has become more popular because of their economic efficiency. Unlike traditional downhole monitoring, it is possible to install tens, hundreds or even thousands of seismic sensors at the surface or at shallow depths. These generally provide superior azimuthal coverage of the energy radiated by microseismic events as compared to the coverage provided by one or two seismic arrays that are typically used in traditional downhole monitoring. However, at the same time, surface and/or shallow arrays tend to suffer from increased signal attenuation as a result of longer source and receiver distances, together with increased noise levels. Hence, improving the signal to noise ratio is a significant issue for improved event detection and characterization.

Acquired microseismic data, such as microseismic surface recordings or the like, is often dominated by strong and variable surface noise—such as noise associated with surface activities, pumps and/or the like—with only sparse and often weak microseismic signals of interest. As such, the acquired microseismic data may comprise noise which is dominant over microseismic signals of interest contained therein.

Methods for reducing noise contained in microseismic data may involve:

applying a bandpass filter to the microseismic data so as only to allow only certain frequencies (e.g. 30 Hz to 80 Hz) to contribute to the processed microseismic data;

or

coherent removal of noise from the microseismic data, which may involve identifying and removing noise having one or more well defined frequencies, or a well-defined range of frequencies, from the microseismic data.

### SUMMARY

In a first aspect, the invention may provide: a method for processing microseismic data, comprising: receiving the microseismic data; and applying a filter to the microseismic data, wherein the filter is configured to whiten the frequency spectrum of the microseismic data.

The filter configured to whiten the frequency spectrum of the microseismic data may be referred to as a “whitening filter” herein.

A “white” frequency spectrum can be viewed as a frequency spectrum where all frequencies have equal amplitude. Such a frequency spectrum may be viewed as corresponding to a discrete time-series containing “white” noise, where the sample values have a zero-mean and there is no statistical correlation of samples within the selected time period.

Hence, microseismic data whose frequency spectrum has been “whitened” can be viewed as a frequency spectrum whose frequency spectrum has been broadened, flattened and/or equalised. Thus, any one or more of the terms “broaden”, “flatten” and/or “equalise” may be used interchangeably with the term “whiten” herein.

Applying a whitening filter to the microseismic data may have the effect of reducing the amplitude of repetitive/periodic elements appearing in the microseismic data.

As would be appreciated by one skilled in the art, an assessment of whether microseismic data has or has not been “whitened” could be achieved by visually comparing the microseismic data before and after the filter has been applied, e.g. as described below with reference to FIG. 4.

An assessment of whether microseismic data has or has not been “whitened” could additionally or alternatively be achieved using an autocorrelation of the microseismic data (before and after the filter has been applied). Autocorrelation is a standard procedure used to obtain information about the repeating/periodic elements in a set of data. An auto-correlation of the microseismic data (before and after the filter has been applied) could be used to show the periodic nature of the noise in the microseismic data (before and after the filter has been applied), where the “side-lobes” of the auto-correlation could be used to ascertain the relative strength of and the periodic interval of the noise, thereby allowing an objective determination to be made of whether the microseismic data has been whitened.

This first aspect of the invention is based on an observation by the inventor that microseismic data often contains a significant amount of noise that is repetitive/periodic. Such repetitive/periodic noise in microseismic data may, for example, be caused by well-head machinery, hydraulic fracture pumps, other well-head installations, any local mechanism or electrical equipment, road or rail systems or natural effects such as wind, rain, vegetation or animals.

In contrast to the repetitive/periodic noise in microseismic data, a signal of interest (e.g. caused by a microseismic event) in microseismic data is usually a transient, i.e. non-periodic, signal of low amplitude. If the amplitude of the signal of interest is at, similar to, or below that of the noise, the inventor has observed that it can be very difficult or even impossible to identify the signal of interest in the microseismic data, since at such amplitudes the signal of interest can be dominated by noise.

The inventor has observed that applying a whitening filter to microseismic data can reduce the amplitude of repetitive/periodic elements in the microseismic data, without impacting significantly on any low amplitude transient elements that may be present. Since, as noted above, the signal of interest is often a low amplitude transient element in the microseismic data, applying a whitening filter to the microseismic data has the effect of reducing the amplitude of repetitive/periodic noise in the microseismic data, without impacting significantly on any low amplitude transient signal of interest that may be present in the microseismic data, thereby helping any transient signal of interest that may be present in the microseismic data to stand out more clearly from noise in the microseismic data.

Thus, the method may allow for a very weak signal of interest to be identified in the microseismic data, even where it would have been very difficult or even impossible to identify the signal of interest in the microseismic data prior to applying the filter to the microseismic data.

Accordingly, the method may include: identifying a signal of interest caused by a microseismic event in the microseismic data to which the filter has been applied, wherein the signal of interest was not identified prior to applying the filter to the microseismic data.

In some embodiments, the filter applied to the microseismic data is a deconvolution filter.

If the filter applied to the microseismic data is a deconvolution filter, the method according to the first aspect of the invention may comprise method for processing microseismic data that includes receiving the microseismic data; and applying a deconvolution filter to the microseismic data.

In general, applying a deconvolution filter to a set of data has the effect of modifying repetitive/periodic elements in the data so as to whiten the frequency spectrum of the data (to some extent). This makes a deconvolution filter a good candidate for the filter configured to whiten the frequency spectrum of the microseismic data.

Conventionally, deconvolution filters are designed/configured to protect a known/estimated signal of interest or to modify a known/estimated signal of interest in a predictable way. However, in the case of the present invention, the signal of interest need not be known/estimated, and instead the deconvolution filter may be used to whiten the frequency spectrum of microseismic data.

As would be appreciated by a skilled person, there are many different types of deconvolution filter that could be applied to the microseismic data. For example, the deconvolution filter could be a gapped deconvolution filter, a spiked deconvolution filter and/or the like.

In conventional seismics, a gapped deconvolution filter is usually used to enhance a repeating signal of interest in relation to noise, whereas a spiked (or “spiking”) deconvolution filter is usually used to sharpen a signal so it can more clearly be seen.

In some embodiments, the deconvolution filter applied to the microseismic data is a spiked deconvolution filter, since spiked deconvolution filters are typically designed for the purpose of whitening. However, experimental work by the inventors has shown that a wide variety of deconvolution filters can provide the desired whitening effect, so the use of a spiked deconvolution filter is not a requirement.

In some embodiments, before applying the deconvolution filter to the microseismic data, the deconvolution filter may be designed/configured using a design time-window, wherein the design time-window is a portion of microseismic data that influences the deconvolution filter. Designing/configuring the deconvolution filter using a design time-window is a technique known to those skilled in the art and does not require further explanation herein.

In an embodiment of the present invention, the design time-window contains repetitive/periodic noise that is similar to repetitive/periodic noise contained in the microseismic data to which the filter is subsequently applied. In this way, the filter is better able to reduce the amplitude of repetitive/periodic noise in the microseismic data when the filter is applied to the microseismic data.

The design time-window may be a portion of the microseismic data to which the filter is subsequently applied, but this is not essential. In some embodiments, the design time-window has a duration (or “length”) that is relatively long, for example 4 seconds or more, 5 seconds or more, 10 seconds or more, 20 seconds or more, or even 30 seconds or more.

In this way, repetitive/periodic noise in the design time-window dominates any transient signal of interest that may (or may not) be present in the design time-window, thereby helping to ensure that applying the deconvolution filter to the microseismic data has the effect of reducing the amplitude of repetitive/periodic noise in the microseismic data, without significantly impacting on any low amplitude signal of interest that may (or may not) be present.

In experimental work, the inventor has found that design time-windows as long as a minute have been effective. The inventor believes longer design time-windows should also be effective.

The design time-windows and application time-windows may be incremented in time so that recorded data of any duration may be processed (application time-windows can be understood as portions of microseismic data to which the filter is applied). The lengths and increments for each of the design and application time-windows may be identical or different. Later windows may be arranged to overlap preceding windows or the windows can be separated. The output from sequential time-windows can be tapered and merged so that filters change from one time-window to the next. Manipulating time-windows in this way is well known to those skilled in the art.

The design time-window does not need to include the signal of interest and indeed, as noted above, may have a duration that is long enough so that any signal that may be contained is dominated by repetitive/periodic noise. Moreover, as noted above, the present method has been found to be capable of identifying a signal of interest that, prior to the filter being applied to the microseismic data, was difficult or even impossible to identify.

Thus, in the present method, the length and/or starting position of the design time-window may be determined before a signal of interest is identified in the microseismic data, wherein that signal of interest was not identified until after the filter was applied to the microseismic data.

Deconvolution filters may be “single channel” or “multi-channel”. A “single channel” deconvolution filter can be viewed as a filter that is designed/configured and applied on a channel by channel basis, i.e. such that a different filter is applied to each channel. A “multi-channel” deconvolution filter can be viewed as a filter that is designed/configured based on multiple channels, and each filter can be applied to one or more channels.

In one embodiment, the deconvolution filter applied to the microseismic data is a single channel filter because a single channel process generally makes no assumptions about signal(s) and the noise on any other channels. Note that in the context of microseismic data, a “channel” is sometimes referred to as a “trace”.

As would be appreciated by a skilled person, a deconvolution filter will typically have an operator length, which can be understood as effectively being the length of the filter in the time-domain. For the methods described herein, the operator length is chosen to be long enough for the filter to whiten the frequency spectrum to a desired extent. The inventor believes a wide variety of operator lengths would be possible depending on application requirements.

The inventor notes that it is known to apply a deconvolution filter to “conventional” seismic data, i.e. seismic data in which a signal of interest is generated by imparting energy to the earth at one or more source locations (for example, by way of controlled explosions). When applying a deconvolution filter to conventional seismic data, the deconvolution filter is typically designed/configured based on a short design time-window (e.g. 1 or 2 seconds of conventional seismic data), the length and starting position of which are selected such that a known/estimated repetitive signal of interest of large amplitude (caused by imparting energy to the earth at one or more source locations) is thought to dominate any noise contained in the design time-window. In other words, in conventional seismics, the length and starting position of the design time-window are selected to capture the known/estimated repetitive signal of interest (so as to capture the known/estimated repetitive signal of interest when it is at its clearest). In this way, the deconvolution filter used in conventional seismics may be seen as being designed/configured using a known/estimated signal of interest. Assuming that the design time-window of conventional seismic data is well chosen (e.g. assuming that there is a “good” estimate of the repeating signal of interest), applying the deconvolution filter to the conventional seismic data is able to have the effect of changing the relationship between the repeating signal of interest and noise in a helpful way, e.g. by increasing the signal to noise ratio, sharpening the signal of interest or removing ghost signals.

In contrast, for the present invention, the length and/or starting position of the design time-window is/are determined without reference to (or without knowledge of) a signal of interest in the microseismic data. That is, there is no relationship between the length and/or starting position of the design time-window and a known/estimated signal of interest.

Indeed, for embodiments of the present invention, the length and/or starting position of the design time-window may be determined before a signal of interest in the microseismic data has been identified, since applying the filter may be used in the process of identifying a signal of interest that was not previously identified. As noted above, the signal of interest may be identified in the microseismic data to which the filter has been applied, wherein the signal of interest was not identified prior to applying the filter to the microseismic data.

In some embodiments, for the present invention, the length and/or starting position of the design time-window may be arbitrarily selected.

Whilst the filter may be a deconvolution filter, other alternative filters may be configured in some embodiments to whiten the frequency spectrum of the microseismic data. For example, such alternative filters could be configured to compute the frequency spectra and equalise the amplitudes at each frequency sample e.g. by multiplication, addition, or division. As another example, a filter in the time domain could be designed from the inverse frequency spectrum so that, when convolved in the time domain, the frequency spectrum is flattened. Further alternative filters could also be conceived/created.

In view of the above considerations, the filter applied to the microseismic data may be designed/configured using noise in the microseismic data (rather than using a known/estimated signal of interest, as is the case for conventional seismics). As noted above, one way in which this can be achieved is for the filter to be designed/configured based on a design time-window of microseismic data that is adequately long (e.g. 5 or more seconds) such that repeating noise is thought to be the dominant repeating element in the time window.

In view of the above considerations, the filter applied to the microseismic data may be designed/configured based on a design time-window of microseismic data in which repeating noise is the dominant repeating element. An auto-correlation of the design time-window could be used to show the periodic nature of the noise in the design time-window, where the “side-lobes” of the auto-correlation would show the relative strength of and the periodic interval of the noise.

Applying a filter to the microseismic data may be performed in addition to other, more conventional, noise reduction steps. For example, the method of an embodiment of the present invention may include: applying a bandpass filter to the microseismic data so as only to allow only certain frequencies (e.g. a certain range of frequencies) to contribute to the processed microseismic data; and/or coherent removal of noise from the microseismic data, e.g. by identifying and removing noise having one or more well defined frequencies, or a well-defined range of frequencies, from the microseismic data.

The method may also include, after applying the filter (and optionally after applying other noise reduction steps), processing the microseismic data to determine properties of/parameters related to a subsurface section of the earth.

The microseismic data may include one or more signals of interest caused by one or more microseismic events.

Herein, the term “microseismic event” may be understood as an event which creates elastic waves underground, but whose effects at the surface of the earth are not discernible without specialist equipment. For example, a microseismic event may be defined as an event having a moment magnitude of less than zero. The moment magnitude scale is well understood by those in the art, and need not be explained further herein.

As would be appreciated by a skilled person, the elastic waves created by a microseismic event may include compressional waves (“p-waves” or “acoustic” waves) and/or shear waves (“s-waves”). For the purposes of this disclosure, the term “elastic wave” does not require the presence of both compressional and shear waves. That is, the term “elastic” wave may, in some cases, refer only to a p-wave or only to an s-wave.

In general, the microseismic data will include a plurality of waveforms, wherein each waveform has been acquired by a respective receiver. Thus, each subset of microseismic data will generally include a plurality of waveforms, wherein each waveform has been acquired by a respective receiver. A waveform acquired at a receiver is commonly referred to as a “trace”, and may also be referred to as a “channel”. The variation of a waveform with time is often physically represented (e.g. on paper) by a “wiggle trace”.

The method may be performed by a processing device, e.g. a computer.

The microseismic data may be received at the processing device.

The microseismic data may be received at the processing device (directly or indirectly) from a plurality of receivers used to acquire the microseismic data.

In a second aspect, a method for processing microseismic data comprises receiving the microseismic data; and applying a deconvolution filter to the microseismic data.

Further optional features of the second aspect will now be set out. These are applicable singly or in any combination with the first aspect of the invention.

The method may include any step or feature described with reference to the first aspect of the invention. For example, the deconvolution filter may be configured to whiten the frequency spectrum of the microseismic data as set out in the first aspect of the invention.

The method may further comprise processing the filtered microseismic data to determine properties of and/or parameters associated with a subterranean section of the earth.

The deconvolution filter may comprise a gapped deconvolution filter and the filter may be designed using received noise.

The deconvolution filter may comprise a spiking (i.e. a “spiked”) deconvolution. The filter may be designed using received noise.

The received noise may be measured by one or more seismic receivers.

The received noise may comprise a dominant part of the received microseismic data

The received noise may be considered to be repetitive in nature.

Properties of the repetition may be used in the design of the deconvolution filter.

The deconvolution filter may be configured to filter recurring elements in the received microseismic data.

A third aspect of the invention comprises a method for acquiring and processing microseismic data using a plurality of receivers to acquire microseismic data; and processing the microseismic data according to the first aspect or second aspect of the invention.

Further optional features of the third aspect of the invention will now be set out. These are applicable singly or in any combination with the first aspect or second aspect of the invention.

The plurality of receivers may include a plurality of geophones (which may be single-component or multiple-component geophones), a plurality of accelerometers, a plurality of hydrophones, and/or a plurality of any other sensors that respond to the arrival of an elastic wave.

The plurality of receivers may be arranged in one or more receiver arrays, each receiver array including a plurality of receivers.

In some embodiments, one or more of the receivers (or receiver arrays, if the plurality of receivers are arranged in one or more receiver arrays) are disposed at the surface. In some embodiments, all of the receivers are disposed at the surface. However, in the forgoing arrangements, one or more of the receivers may be disposed underground, e.g. in a borehole. Recently the use of surface and/or shallow borehole microseismic arrays has become more popular because of their economy and insensitivity to certain noise modes.

A fourth aspect of the invention may provide a computer-readable medium having computer-executable instructions configured to cause a computer to perform a method according to the first and/or second aspect of the invention.

Herein, the term “computer” is intended to refer to any processing device, not just a general purpose computer.

A fifth aspect of the invention may provide an apparatus for acquiring and/or processing microseismic data.

Further optional features of the fifth aspect of the invention will now be set out. These are applicable singly or in any combination with the first, second, third or fourth aspects of the invention.

The apparatus may include a processing device configured to perform a method according to the first and/or second aspect of the invention.

The apparatus may include a plurality of receivers configured to acquire the microseismic data.

The plurality of receivers may include a plurality of geophones (which may be single-component or multiple-component geophones), a plurality of accelerometers, a plurality of hydrophones, and/or a plurality of any other sensors that respond to the arrival of an elastic wave.

One or more of the receivers (possibly all of the receivers) may be disposed at the surface and/or one or more of the receivers may be disposed underground.

The invention also includes any combination of the aspects and features described except where such a combination is clearly impermissible or expressly avoided.

### BRIEF DESCRIPTION OF THE DRAWINGS

The present disclosure is described in conjunction with the appended figures. It is emphasized that, in accordance with the standard practice in the industry, various features are not drawn to scale. In fact, the dimensions of the various features may be arbitrarily increased or reduced for clarity of discussion.

FIG. 1 is a schematic illustration of a system for acquiring microseismic data related to hydraulic fracturing.

FIG. 2 is a flow chart showing a method for processing microseismic data, in accordance with an embodiment of the present invention.

FIG. 3 shows approximately 20 sec of a first set of microseismic data (a) before a deconvolution filter has been applied to the first set of microseismic data, and (b) after the deconvolution filter has been applied to the first set of microseismic data, in accordance with an embodiment of the present invention.

FIG. 4 shows a frequency spectrum compiled from approximately 30 sec of the first set of microseismic data (a) before the deconvolution filter has been applied to the first set of microseismic data, and (b) after the deconvolution filter has been applied to the first set of microseismic data, in accordance with an embodiment of the present invention.

FIG. 5 shows approximately 1.5 sec of the first set of microseismic data of FIG. 3 (a) before the deconvolution filter has been applied to the first set of microseismic data, and (b) after the deconvolution filter has been applied to the first set of microseismic data, in accordance with an embodiment of the present invention.

FIG. 6 shows approximately 0.5 sec of a second set of microseismic data (a) before the second set of microseismic data has been processed, (b) after a bandpass filter has been applied to the second set of microseismic data, and (c) after a deconvolution filter and the bandpass filter have been applied to the second set of microseismic data, in accordance with an embodiment of the present invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DESCRIPTION

Embodiments of the present invention relates to processing microseismic data. Some embodiments may provide for removing noise from acquired microseismic data. In some embodiments, the microseismic data with reduced noise may be processed to determine properties of/parameters related to a subsurface section of the earth. For example, the microseismic data with reduced surface noise may be processed to provide for analysis of a hydraulic fracturing operation, monitoring operation of a subsurface reservoir such as a hydrocarbon reservoir, determination of locations of fractures in a subsurface of the earth and/or the like.

The ensuing description provides exemplary embodiment(s) only, and is not intended to limit the scope, applicability or configuration of the invention. Rather, the ensuing description of the exemplary embodiment(s) will provide those skilled in the art with an enabling description for implementing an exemplary embodiment of the invention, it being understood that various changes may be made in the function and arrangement of elements without departing from the scope of the invention.

Specific details are given in the following description to provide a thorough understanding of the embodiments. However, it will be understood by one of ordinary skill in the art that embodiments maybe practiced without these specific details. For example, well-known circuits, processes, algorithms, structures, and techniques may be shown without unnecessary detail in order to avoid obscuring the embodiments.

As disclosed herein, the term “computer-readable medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

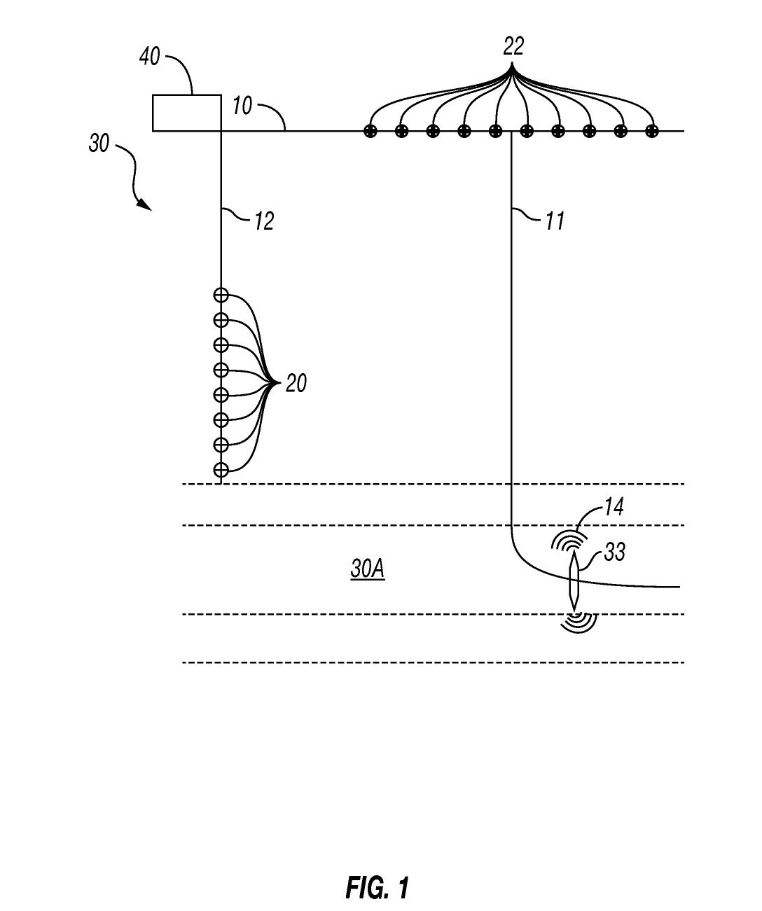

FIG. 1 is a schematic illustration of a system for acquiring microseismic data related to hydraulic fracturing.

A fracturing borehole 11 extends from a surface 10 through an Earth formation 30. A geophone or accelerometer receiver array 22 may be disposed at the surface 10, and/or in boreholes at shallow depths, typically less than 300 m below the surface. Other geophone or accelerometer receiver arrays 20 may be disposed in one or more deeper monitoring boreholes 12 extending from the surface 10 through the Earth formation 30, and typically spaced hundreds of meters from the fracturing borehole 11. The geophone or accelerometer receiver arrays 20, 22 may each comprise a plurality of geophone receivers or accelerometers. Geophones or accelerometers in the geophone or accelerometer receiver arrays 20, 22 may be spaced of the order of tens of meters apart, or any separation. The geophones or accelerometers may be regularly or irregularly spaced.

During hydraulic fracturing, a fluid (not shown), which may include solid particles (e.g. a proppant), may be pumped from the surface 10 into the fracturing borehole 11 so as to cause the Earth formation 30 surrounding the fracturing borehole 11 to undergo a microseismic event, resulting in the generation of a fracture 33 in the Earth formation 30. In the hydrocarbon industry, the fluid may be pumped down the fracturing borehole 11 to provide for the fracturing of a hydrocarbon bearing layer 30A in the Earth formation 30. In such an arrangement where the portion of the Earth formation 30 being fractured is the hydrocarbon-bearing layer 30A, the fracture 33 is produced at least partially within the hydrocarbon-bearing layer 30A. By generating the fracture 33 at least partially within the hydrocarbon-bearing layer 30A, production channels may be set up in the hydrocarbon-bearing layer 30A allowing for flow of the hydrocarbons in the hydrocarbon-bearing layer 30A to the fracturing borehole 11.

One possibility is that the hydrocarbon-bearing layer is a shale. A reservoir which is a shale is generally of low permeability and is stimulated by fracturing in order to achieve production, but incorporates natural fractures which become connected to the newly-formed fracture.

During the fracturing process, elastic waves, including acoustic waves 14, may be generated by the fracture 33 and the acoustic waves 14 may propagate through the Earth formation 30 and be detected by the geophone or accelerometer receiver arrays 20, 22. As such, the geophone or accelerometer receiver arrays 20, 22 may be used to acquire induced motion data (microseismic data) related to the hydraulic fracturing procedure taking place in the fracturing borehole 11. Any geophone receivers in the geophone arrays may comprise three-component geophones and may provide directional (three-dimensional) data for the received acoustic waves 14. Alternatively or additionally, any geophone receivers in the geophone arrays may comprise one component geophones, usually arranged to measure the vertical component of the wavefield. The data received by the geophone or accelerometer receiver arrays 20, 22 may be recorded and then processed and/or transmitted to a processing device 40 for processing.

Generally, the surface/shallow geophone or accelerometer receiver array 22 is less costly to set up than the deep array 20. However, the source mechanism of the microseismic event is one of the primary factors causing variations in the amplitude of the microseismic wave at or near the surface 10. The variation of the radiation pattern results largely from the difference in the fault plane parameters and amount of non-double couple component, the latter being particularly significant for hydraulic fracture induced microseismic events.

In some embodiments of the present invention, a deconvolution filter may be used to process acquired microseismic data to improve the signal-to-noise ratio (“SNR”) of the acquired microseismic data. In some embodiments, the deconvolution filter may be designed based almost exclusively on the noise, but may be applied to both the noise and a microseismic signal (of interest) in the acquired microseismic data. In some embodiments of the present invention, a deconvolution filter may whiten the amplitude spectrum of the noise, and may pass the transient signal of interest largely unchanged. Thus, in some embodiments, the deconvolution filter may increase the SNR of acquired microseismic data. In some embodiments, the deconvolution filter may comprise a predictive gap of one time-sample, in which case the deconvolution filter may be called a spiking (or “spiked”) deconvolution filter, or a longer gap, in which case the deconvolution filter may be called a gapped deconvolution filter.

In general terms, a deconvolution comprises an algorithm-based process to reverse the effects of a convolution on recorded data. In general, the object of a deconvolution is to find the solution of a convolution equation of the form:

F*G=H

In signal processing, H may comprise acquired data and F and G may comprise convolved signals and/or noise.

In conventional seismic processing, a deconvolution may describe an inverse filtering process that modifies a known or stationary minimum phase signal in a convolutional process, where the input has added random noise or long-period reverberations. In such processing, the seismic convolution model is assumed to represent the earth's reflectivity series convolved with some input seismic signal. In conventional seismic applications, a gapped deconvolution filter is designed to modify the signal to some desired/estimated output signal, and the spiked deconvolution is designed to broaden, flatten and/or equalise the frequency spectrum (or “whiten” the frequency spectrum). The signals of interest in conventional seismic processing are known to be recurring elements in the input time-series and the repeating signal of interest is usually estimated from an autocorrelation of the input data. In conventional seismic deconvolution, if the estimate of the signal in the input data is poor then the SNR will decrease and the answer is generally to try to remove more noise from the input data to improve the estimate of the signal.

In conventional seismic deconvolution, the input data may be dominated by strong noise but there is always an underlying stationary signal convolved with a reflectivity series. The deconvolution filter may broaden the signal spectrum and pass random noise. In other words, the deconvolution filter is designed to recognise and pass the known/estimated (desired or modified) signal wavelet. Transient noise is filtered but output by the process. If strong noise affects the filter design, this will degrade the output signal.

In some embodiments of the present invention, there is no assumption of signal in the input data and recurring elements in the input (microseismic data) are instead considered as being related to persistent noise, receiver coupling effects and/or the like. The deconvolution operator may therefore broaden the dominant noise spectrum, or “whiten” the dominant noise, and the filter may pass both transient noise and signal of interest. In embodiments of the present invention, the noise may be considered as having recurring properties and may be modified by the deconvolution filter, whereas the signal may be considered as transient and so passes through the filter, which may be a spiking (or “spiked”) deconvolution filter.

In embodiments of the present invention, when there is a single weak microseismic signal of interest in the input time-series, or a portion of the time-series selected manually or automatically (known as the design time-window), the microseismic signal of interest may contribute almost nothing to the autocorrelation of the noise such that the deconvolution filter passes the signal as an error in the noise estimation. Transient noise modes will also be passed in the same way, but in embodiments of the present invention, a transient noise mode may comprise a signal.

In conventional seismic deconvolution the noise is often “source generated” or related to the source mechanism and it occurs for a time period related to the source time, or source activation time. In microseismic there is typically no input source so there is no “source generated” noise. Typical microseismic noises are related to the treatment well-head machinery, hydraulic fracture pumps, other well-head installations, or any local mechanical or electrical equipment, or road or rail systems, or natural effects such as wind, rain, vegetation, animals, or many other possible effects. These microseismic noises may be affecting recording sensors on a small-scale or large scale, but they are often reoccurring, or slowly changing noise characteristics that may appear to be well defined in an autocorrelation of the recorded data. The microseismic signal will often be an isolated transient event that has a different frequency spectrum to one, several, or all of the noise mechanisms.

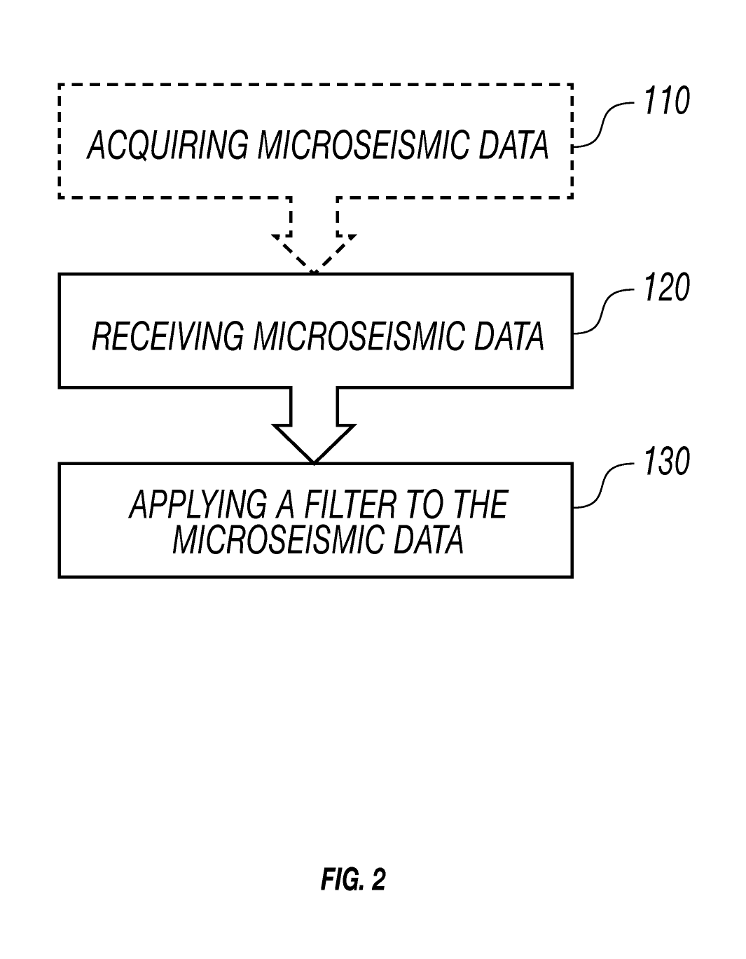

A method for processing microseismic data in accordance with an embodiment of the present invention is illustrated in FIG. 2.

In 110, the method may include acquiring microseismic data, e.g. using some/all of the plurality of receivers 20, 22 of FIG. 1.

In 120, the method may include receiving the microseismic data, e.g. at the processing device 40 of FIG. 1.

In 130, the method may include applying a filter to the microseismic data. In some embodiments, the filter is a deconvolution filter configured as described in detail above.

### EXPERIMENTAL EXAMPLES

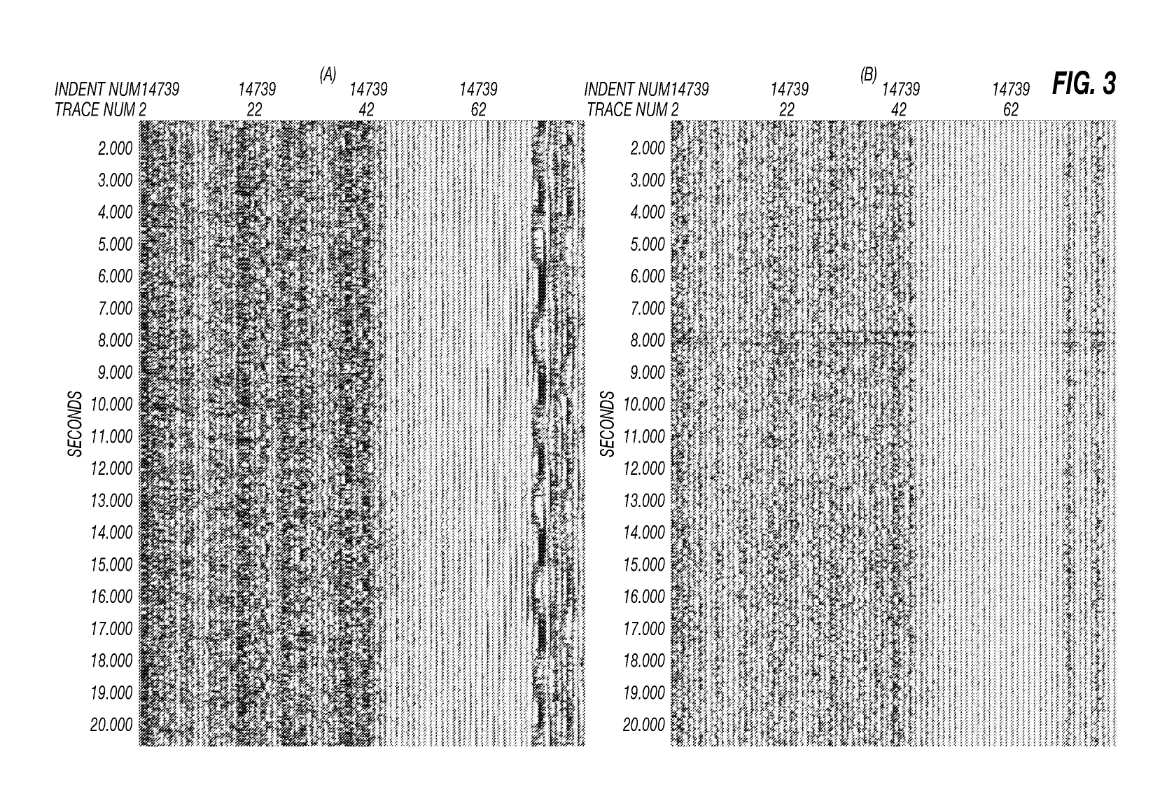

The microseismic data shown in FIG. 3 is approximately 20 sec of recorded data from 80 sensors. The sensors were arranged in a linear array at ground level at 16 feet intervals. The data is plotted in FIG. 3 as vertical traces that show the sensor output as a function of time. The traces are a “wiggle-area” display, with positive amplitudes plotted as solid black areas and negative amplitudes as wiggles. This visual display reinforces the coherent data on adjacent traces.

FIG. 3(a) shows raw data and FIG. 3(b) shows the same data after the deconvolution (or “whitening”) filter was applied.

The deconvolution filter used was designed/configured using a design time-window, wherein the design time-window was a portion of the microseismic data approximately 30 seconds in length. The deconvolution filter was a single channel filter designed/configured and applied on a channel by channel basis, i.e. such that the filter was designed and applied to each trace individually. The active filter in this example was approximately 500 ms long (i.e. the operator length of the filter was 500 ms).

In FIG. 3(b), the signals of interest are the responses that appear at approximately the same time on each trace across this array, and in this case can be seen on FIG. 3(b) at around 8 sec.

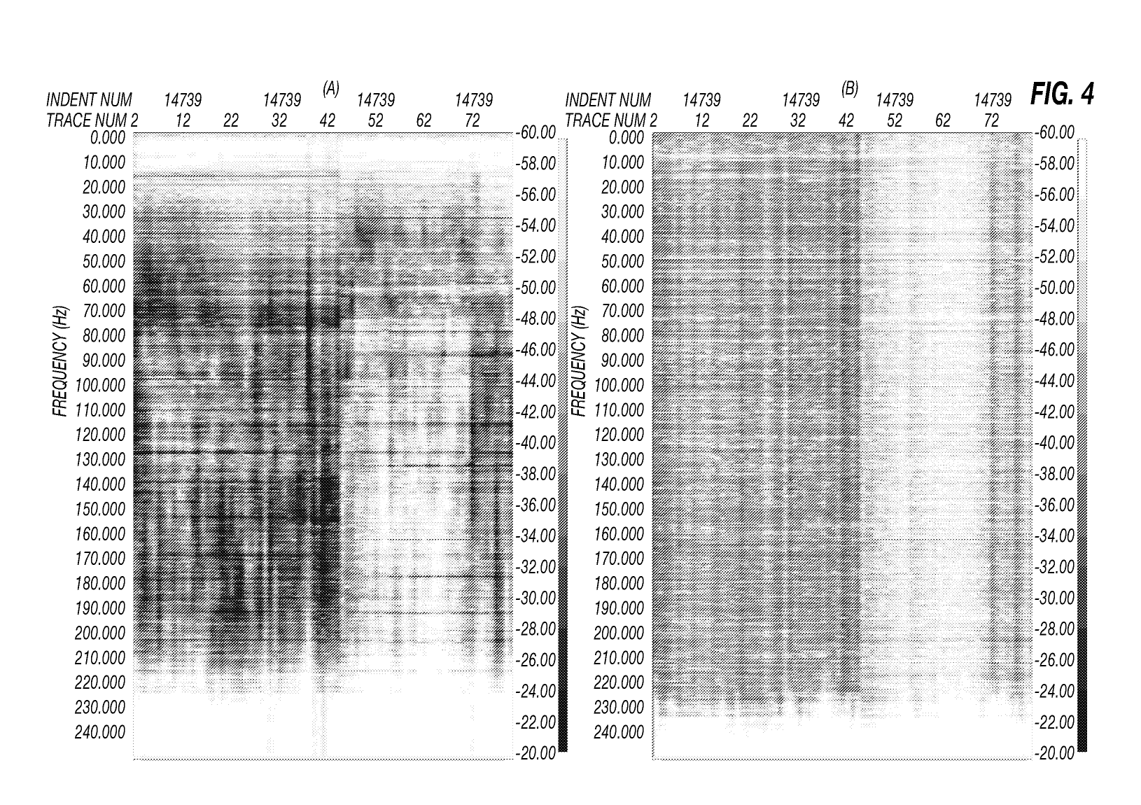

FIG. 4(a) and FIG. 4(b) are frequency spectra showing the same microseismic data shown in FIG. 3(a) and FIG. 3(b).

Thus, FIG. 4(a) and FIG. 4(b) each show frequency spectra computed from 30 seconds of data for each of the 80 sensors. The spectra are plotted with greyscale showing the relative amplitude against the vertical frequency axis. The greyscale bar on the right shows the amplitude scale in dB, with dark-grey as the relatively strong signals and white as the weaker signals.

FIG. 4(a) shows the raw data and FIG. 4(b) shows the same data after the deconvolution filter has been applied. The deconvolution filter has clearly balanced the relative amplitudes across the frequency range for each trace, and therefore has clearly whitened the microseismic data, although there are still amplitude variations from trace to trace because the average trace energy in each design window can be different.

The signals of interest are not distinguishable in the spectra of FIG. 4(a) and FIG. 4(b), because these signals of interest contribute only a small part of the frequency spectra. However, the raw spectra of FIG. 4(a) do show a range of amplitude variations across the traces, which variations are caused by a variety of different noise mechanisms.

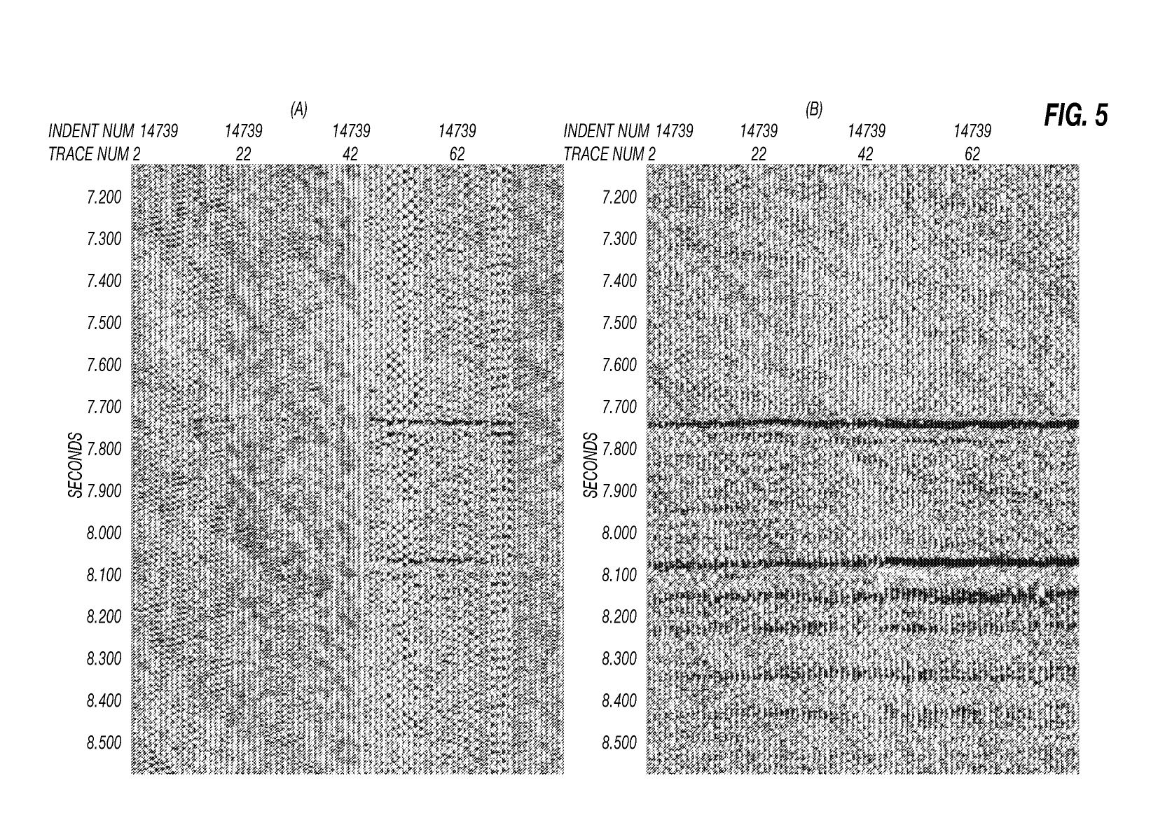

FIG. 5(a) and FIG. 5(b) each show approximately 1.5 sec of the same traces from FIG. 5, but on a larger time-scale.

Each trace in FIG. 5(a) and FIG. 5(b) has been scaled by a value that makes the average data value for each trace in this display window equivalent to the trace spacing. That is, the average data value on each trace is plotted so it touches the adjacent zero-trace position. This plot normalisation scheme emphases the dominant data on each trace.

Again, FIG. 5(a) shows the raw data and FIG. 5(b) shows the same data after the deconvolution filter has been applied. The signals of interest are the responses that appear at approximately the same time on each trace, for instance at 7.75 sec, and 8.1 sec.

Although two of the signals of interest can be seen on FIG. 5(a), these signals would have been very difficult to automatically detect in the raw data because the average signal energy on each trace is at a similar or lower level than the noise. Therefore, applying the deconvolution filter to the raw data has made it much easier to identify these two signals of interest.

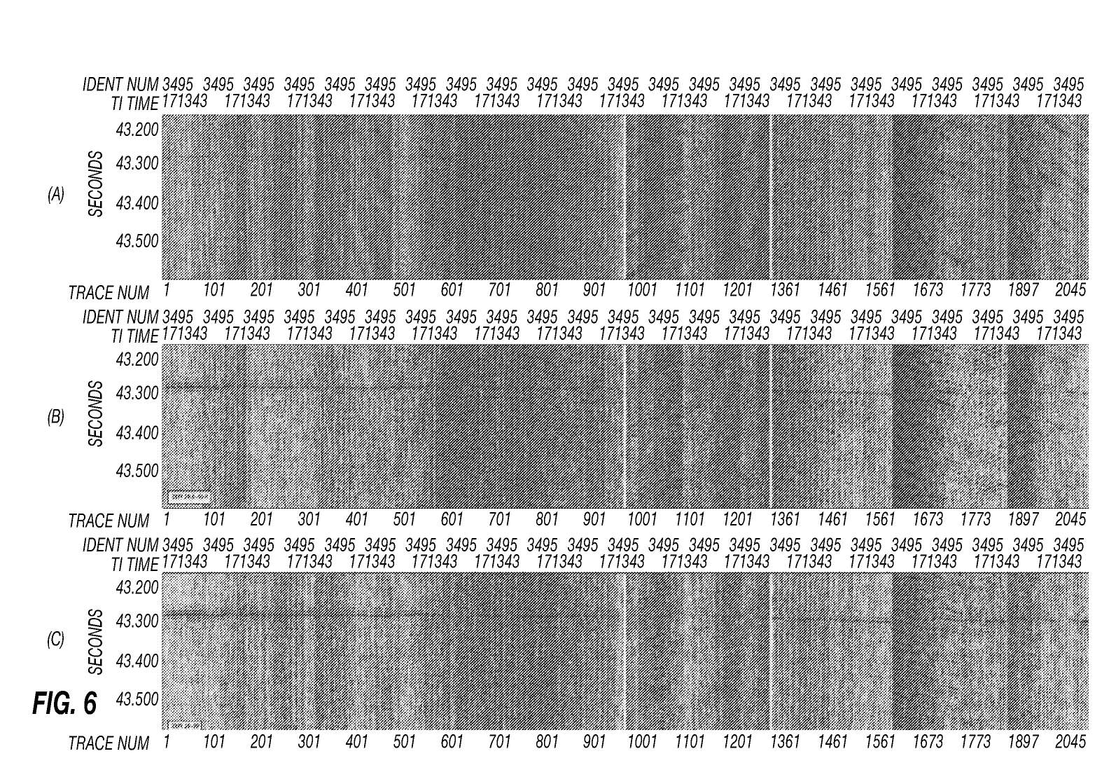

FIG. 6 illustrates: (a) raw microseismic data; (b) the microseismic data of FIG. 6(a) after a bandpass filter (in this case a 30-80 Hz bandpass filter) has been applied to the microseismic data and (c) the microseismic data of FIG. 6(a) after a deconvolution filter and a bandpass filter (the same 30-80 Hz bandpass filter used for FIG. 6(b)) has been applied to the microseismic data.

FIG. 6 shows approximately 2000 traces on the X axis and approximately 0.5 seconds of recorded time on the Y axis. Each trace is the recorded time function from a surface sensor array positioned in an extremely noisy environment within a few hundred feet of well-head pumps. From the top, raw data, raw data with a band-pass filter 30-80 Hz applied and raw data with deconvolution and the band-pass filter of 30-80 Hz applied.

In the example of FIG. 6(c), the filter used was a spiked (or “spiking”) deconvolution filter with a design time-window of 40 seconds.

In the example illustrated in FIG. 6(b), a relatively high amplitude microseismic signal is shown so that the amplitude is clearly visible on parts of the array with the bandpass filter applied. The signal is visible because in those parts of the array, the SNR is good for the selected frequency pass-band.

In the example illustrated in FIG. 6(c), there is improved SNR in most locations compared to the bandpass filter alone, indicating that more noise has been removed by the deconvolution in frequency bands where the simple bandpass filter has not been able to separate the signal and noise.

In summary, using a deconvolution filter to process acquired microseismic data has been found to be an effective method to increase the SNR of the acquired m icroseism is data.

Variable gap-lengths and spiking deconvolution with variable levels of white noise added to the inverse filter design, various design windows and operator lengths have been tested and it has been found that the aforementioned processes are robust and produce noise attenuation of the acquired microseismic data.

The inventor has also found that where there is a strong narrow band periodic noise on the input, such as “50 or 60 Hz line electrical noise”, then the deconvolution filter strongly attenuates this noise. This is because any repetitive noise will contribute strongly to the auto-correlation and to the estimate of the frequency spectrum and will therefore be dominant in the deconvolution filter. This effect is well-known in linear-prediction filters or notch filters where filters are often designed to attenuate the well-defined periodic noise. In the linear-prediction method the filter design is optimised by using short design windows and short prediction filters that assume a linear trend in the noise over a short time window and the filter is modified and estimated at each new time sample. The notch filter may be a linear filter that is limited to a narrow frequency range or it may be a constant filter that attenuates any data within a narrow frequency range.

When used in this specification and claims, the terms “comprises” and “comprising”, “including” and variations thereof mean that the specified features, steps or integers are included. The terms are not to be interpreted to exclude the possibility of other features, steps or integers being present. Thus, for example, the methods described and claimed herein should not be interpreted to exclude the possibility of additional steps being performed that aren't discussed herein.

The features disclosed in the foregoing description, or in the following claims, or in the accompanying drawings, expressed in their specific forms or in terms of a means for performing the disclosed function, or a method or process for acquiring the disclosed results, as appropriate, may, separately, or in any combination of such features, be utilised for realising the invention in diverse forms thereof.

All references referred to above are hereby incorporated by reference for all purposes. While the principles of the disclosure have been described above in connection with specific apparatuses and methods, it is to be clearly understood that this description is made only by way of example and not as limitation on the scope of the invention.

1. A method for processing microseismic data, comprising:
receiving the microseismic data;
applying a filter to the microseismic data, wherein the filter is configured to whiten the frequency spectrum of the microseismic data.

2. A method according to claim 1, wherein the method further comprises:
identifying a signal of interest caused by a microseismic event in the microseismic data to which the filter has been applied, wherein the signal of interest was not identified prior to applying the filter to the microseismic data.

3. A method according to claim 1, wherein the filter applied to the microseismic data is a deconvolution filter.

4. A method according to claim 3, wherein the deconvolution filter applied to the microseismic data is a spiked deconvolution filter.

5. A method according to claim 3, wherein the method further comprises:
before applying the deconvolution filter to the microseismic data, configuring the deconvolution filter using a design time-window, wherein the design time-window comprises a portion of microseismic data that influences the deconvolution filter.

6. A method according to claim 3, wherein the portion of microseismic data selected as the design time-window has a duration of 4 seconds or more.

7. A method according to claim 3, wherein the deconvolution filter applied to the microseismic data is a single channel filter.

8. A method according to claim 3, wherein a length and/or starting position of the design time-window is/are determined without reference to a signal of interest in the microseismic data.

9. A method according to claim 3, wherein a length and/or starting position of the design time-window is/are determined before identifying a signal of interest in the microseismic data.

10. A method according to claim 3, further comprising:
applying a bandpass filter to the microseismic data to only allow a range of selected frequencies to contribute to the processed microseismic data;

11. A method according to claim 3, further comprising:
coherently removing of noise from the microseismic data.

12. A method according to claim 3, further comprising:
after applying the filter, processing the microseismic data to determine properties of/parameters related to a subsurface section of the earth.

13. A method for processing microseismic data, comprising:
Receiving the microseismic data; and
applying the deconvolution filter to the microseismic data.

14. The method of claim 13, further comprising:
Processing the filtered microseismic data to determine properties of and/or parameters associated with a subterranean section of the earth.

15. The method of claim 13, wherein the deconvolution filter comprises a gapped deconvolution filter and the filter is designed using received noise.

16. The method of claim 13, wherein the deconvolution filter comprises a spiking deconvolution and the filter is designed using received noise.

17. The method according to claim 13, wherein the received noise is measured by one or more seismic receivers.

18. The method according to claim 13, wherein the received noise comprises a dominant part of the received microseismic data.

19. The method according to claim 13, wherein the received noise is considered to be repetitive in nature.

20. The method of claim 19, wherein properties of the repetition are used in the design of the deconvolution filter.

21. The method of claim 13, wherein the deconvolution filter is configured to filter recurring elements in the received microseismic data.

22. A method for acquiring and processing microseismic data, wherein the method includes:
using a plurality of receivers to acquire microseismic data; and
a method for processing the microseismic data according to claim 13.

23. A computer-readable medium having computer-executable instructions configured to cause a computer to perform a method according claim 13.

24. An apparatus for acquiring and/or processing microseismic data, wherein the apparatus includes a processing device configured to perform a method according to claim 1.

25. (canceled)
